(19) United States
(12) Patent Application Publication
(10) Pub. No.: US 2009/0228674 A1
(43) Pub. Date: Sep. 10, 2009

(54) DISK ARRAY APPARATUS FOR CONTROLLING START TIMING OF DISK DRIVE

(76) Inventor: Katsumi OUCHI, Kawasaki (JP)

Correspondence Address: BRUNDIDGE & STANGER, P.C., 1700 DIAGONAL ROAD, SUITE 330, ALEXANDRIA, VA, 22314, US

(21) Appl. No.: 12/109,420

(22) Filed: Apr. 25, 2008

(30) Foreign Application Priority Data
Mar. 5, 2008 (JP) 2008-054987

(51) Int. Cl. G06F 12/00; G06F 12/08

(52) U.S. Cl. 711/168; 711/114; 711/E12.019; 711/E12.001

(57) ABSTRACT

To realize a disk array device which suppresses vibrations during HDD spinning-up, there is provided a disk array apparatus, comprising: a plurality of disk drives; and a controller for controlling the plurality of disk drives, the disk array apparatus controlling power of the plurality of disk drives for each disk group including of the plurality of disk drives. The two disk drives included in the same disk group are arranged in sets on one base member. The controller controls to set start timings of the two disk drives constituting the set identical to each other.

### CLAIM OF PRIORITY

The present application claims priority from Japanese patent applications JP 2008-54987 filed on Mar. 5, 2008, the content of which are hereby incorporated by reference into this application.

### BACKGROUND

This invention relates to a disk array device, and more particularly, to a disk array device where vibrations of a hard disk drive are suppressed.

As a conventional technology regarding a disk array device which includes hard disk drives (HDD's) mounted therein at a high density, for example, a disk array device described in JP 2004-178557 A has been known. According to the disk array device described in JP 2004-178557 A, a sufficient cooling effect can be obtained with a weak airflow by disposing a heat radiation member on one side of the HDD's. Thus, the HDD's can be mounted in the disk array device at a high density.

JP 2006-235964 A describes a disk array device where a plurality of HDD blades having HDD's arrayed in a depth direction are mounted in an enclosure. The disk array device described in JP 2006-235964 A can achieve both high-density mounting and maintenance performance of the HDD's.

However, the enclosure including the HDD's mounted therein at a high density is easily affected by heat and vibrations generated from another HDD. Once affected by the vibrations, positioning of an HDD header for writing or reading data takes time, causing a reduction in data transfer speed. The vibrations cause an error in header positioning, and correction of the error takes longer time for data writing or reading.

A main cause of the vibrations is rotation of a platter in the HDD. A basic frequency of generated vibrations is calculated from an inverse number of a rotational speed of the HDD. Components of the generated vibrations include, in addition to the basic frequency, a harmonic component whose frequency is an integral multiple of the basic frequency. As an HDD surface density increases, an influence of vibrations on accuracy of head positioning using servo control increases.

As countermeasures against the vibrations generated by the HDD, JP 2006-146616 A discloses a method which uses a leaf spring. Generally, there has been known a method of supporting an HDD by a rubber cushion washer. As a technology of suppressing vibrations based on arrangement of HDD's in an enclosure, JP 2007-517355 A discloses a technology involving arranging two HDD's simultaneously accessed such that vibrations by an actuator operation are cancelled.

### SUMMARY

As a representative power-saving technology for a disk array device, a MAID technology of turning OFF the power of an unaccessed HDD has been known. According to a MAID function, when a host computer makes an I/O request to the power-OFF HDD, the power of the HDD is turned ON to complete spinning-up, and then data is input or output. To spin up the HDD, a platter has to be rotated by large torque. Thus, vibrations are larger than those during normal rotation.

The disk array device that includes the MAID function is expected to be applied to backing-up which requires only low performance or archive use, which requires HDD's to be mounted at a high density when used in place of a tape library device. However, when the HDD's are mounted at a high density, physical restrictions on countermeasures against vibrations are large because space is limited.

This invention has been made to solve the above problems of the conventional art, and an object of this invention is to realize a disk array device which suppresses vibrations not only during normal rotation but also during HDD spinning-up.

A representative aspect of this invention is as follows. That is, there is provided a disk array apparatus, comprising: a plurality of disk drives; and a controller for controlling the plurality of disk drives. The disk array apparatus controls power of the plurality of disk drives for each disk group including of the plurality of disk drives. The two disk drives included in the same disk group are arranged in sets on one base member. The controller controls to set start timings of the two disk drives constituting the set identical to each other.

According to an aspect of this invention, there can be realized the disk array device using a MAID function of controlling the power of the HDD's, which suppresses vibrations not only during normal rotation but also during HDD spinning-up.

### BRIEF DESCRIPTION OF THE DRAWINGS

The present invention can be appreciated by the description which follows in conjunction with the following figures, wherein:

FIG. 1 is a block diagram showing a configuration of a disk array device in accordance with an first embodiment of this invention;

FIG. 2 is a perspective view showing an additional chassis in accordance with the first embodiment of this invention;

FIG. 3 is an explanatory diagram showing an internal structure of the additional chassis in accordance with the first embodiment of this invention;

FIG. 4 is a perspective view showing an HDD blade in accordance with the first embodiment of this invention;

FIG. 5 is a right side elevation view showing the HDD blade in accordance with the first embodiment of this invention;

FIG. 6 is a left side elevation view showing the HDD blade in accordance with the first embodiment of this invention;

FIG. 7A is a side view showing two HDD's attached to the HDD blade in accordance with the first embodiment of this invention;

FIG. 7B is a sectional view showing the two HDD's attached to the HDD blade in accordance with the first embodiment of this invention;

FIG. 8 is an explanatory diagram showing a RAID configuration management table in accordance with the first embodiment of this invention;

FIG. 9 is an explanatory diagram showing a spare HDD management table in accordance with the first embodiment of this invention;

FIG. 10 is an explanatory diagram showing power supply control of the RAID group in accordance with the first embodiment of this invention;

FIG. 11A to FIG. 11D are explanatory diagrams showing a data recovery process when a failure occurs in the HDD in accordance with the first embodiment of this invention;

FIG. 12 is a flowchart showing a data recovery process when a failure occurs in the HDD in accordance with the first embodiment of this invention;

FIG. 13 is a wave form chart showing residual vibrations generated by an HDD pair in accordance with a second embodiment of this invention;

FIG. 14 is an explanatory diagram showing power supply control of an HDD pair in accordance with the second embodiment of this invention;

FIG. 15 is a block diagram showing an offset circuit in accordance with the second embodiment of this invention;

FIG. 16 is a flowchart showing a process for correcting power supply timing in accordance with the second embodiment of this invention; and

FIG. 17 is an explanatory diagram showing power supply control of a RAID group in accordance with a third embodiment of this invention.

### DETAILED DESCRIPTION OF THE PREFERRED EMBODIMENTS

Preferred embodiments of this invention will be described below referring to the drawings.

### First Embodiment

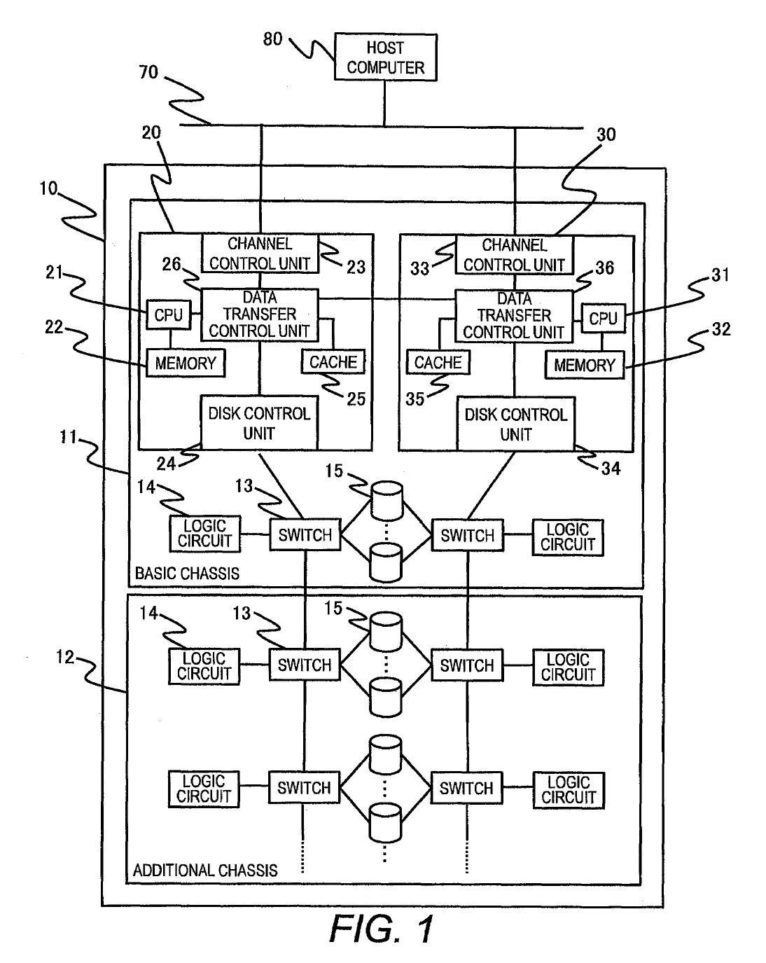

FIG. 1 illustrates a configuration of a disk array device 10 according to a first embodiment of this invention.

The disk array device 10 is coupled to a host computer 80 via a host interface 70. The host computer 80 requests the disk array device 10 to input or output data.

The disk array device 10 includes a basic chassis 11, an additional chassis 12, a fan chassis (not shown), and a power supply chassis (not shown).

The basic chassis 11 includes controllers 20 and 30, HDD's 15, switches 13, and logic circuits 14.

The controller 20 includes a CPU 21, a local memory 22, a cache memory 25, a channel control unit 23, a disk control unit 24, and a data transfer control unit 26.

The CPU 21 is a processor for executing a program stored in the local memory 22 to control the controller 20. The CPU 21 can control a process of inputting or outputting data to or from HDD's 15 installed in the basic and additional chassis 11 and 12, for example, in response to data inputting or outputting requested from the host computer 80.

The local memory 22 stores programs executed by the CPU 21 and various tables (e.g., RAID configuration management table and spare HDD management table described below). It should be noted that a program and data stored in the HDD 15 is copied to the local memory 22 when necessary.

The cache memory 25 is a storage area for temporarily storing write data entered from the host computer 80 to the disk array device 10, and read data output from the disk array device 10 to the host computer 80. The cache memory 25 may include, for example, a nonvolatile memory or a volatile memory backed up by a battery. It should be noted that in the case of the nonvolatile memory, the cache memory 25 can hold stored cache data even when power is cut off.

The channel control unit 23 is an interface coupled to the host computer 80 to receive data I/O request (e.g., block I/O request or file I/O request) from the host computer 80.

The disk control unit 24 is an interface coupled to the HDD 15 to make a data I/O request to the HDD 15 by using a predetermined protocol.

The data transfer control unit 23 controls data transfer between the host computer 80 and an HDD 25 by the instruction from the CPU 21.

It should be noted that the controllers 20 and 30 are duplicated to improve availability.

The controller 30 has the same configuration as that of the controller 20, and includes a CPU 31, a local memory 32, a cache memory 35, a channel control unit 33, a disk control unit 34, and a data transfer control unit 36. It should be noted that the CPU 31, the local memory 32, the cache memory 35, the channel control unit 33, the disk control unit 34, and the data transfer control unit 36 correspond to the CPU 21, the local memory 22, the cache memory 25, the channel control unit 23, the disk control unit 24, and the data transfer control unit 26, respectively.

The data transfer control units 26 and 36 of the controllers 20 and 30 are coupled. Data written in the cache memory 25 of the controller 20 is transferred to the controller 30 to be written in the cache memory 35. Similarly, data written in the cache memory 35 of the controller 30 is transferred to the controller 20 to be written in the cache memory 25. Accordingly, the cache data written in the cache memories 25 and 35 are duplicated. Hereinafter, there will be described the case where the controller 20 is operated.

The HDD 15 stores programs, user data, and the like, and includes, for example, a serial attached SCSI (SAS) interface. The HDD 15 includes a dual I/O ports to improve availability, and is coupled to the controllers 20 and 30 via the switch 13.

The switch 13 is a device for transferring I/O data from the host computer 80 to the HDD 15. The switch 13 can include, for example, an SAS expander. In an example shown in FIG. 1, the number of switches 13 is one corresponding to the logical circuit 14. However, an optional number of switches 13 may be installed.

The logic circuit 14 includes a power supply control register for an HDD pair described below, and a register for controlling lighting of an LED which notifies an access status of each HDD to the outside. Based on a command issued from the CPU 21 of the controller 20, for example, each register can be set inbound. The logic circuit 14 may include, for example, an FPGA, a CPLD, or an ACIC. For example, one logical circuit 14 may be installed for each switch 13. Alternatively, one logical circuit 14 may be installed for a plurality of switches 13.

The switch 13 and the logic circuit 14 are duplexed to improve availability. The HDD 15 of the basic chassis 11 is mounted by a conventional method, and an influence of vibrations generated by rotation of the platter can be ignored.

As in the case of the basic chassis 11, the additional chassis 12 includes HDD's 15, switches 13, and logic circuits 14. Functions of the components (HDD 15, switch 13, and logic circuit 14) are similar to those of the components of the basic chassis 11.

Each of the basic chassis 11 and the additional chassis 12 includes one or a plurality of RAID groups, and one or a plurality of spare disks. The RAID group is configured by, for example, grouping four HDD's 15 (3D+1P). The RAID group is configured by a disk array management terminal (not shown) coupled to the disk array device 10 based on information in the spare HDD management table described below. Among the HDD's 15 in the additional chassis 12, an HDD not allocated as a RAID group is treated as a spare disk.

The fan chassis cools the HDD's 15 in the additional chassis 12. The power supply chassis supplies power to the basic chassis 11 and the additional chassis 12.

The basic chassis 11, the additional chassis 12, the fan chassis, and the power supply chassis can be mounted on, for example, a 19-inch rack.

In the example of FIG. 1, the disk array device 10 includes one basic chassis 11. However, a plurality of basic chassis may be installed. The disk array device 10 includes one additional chassis 12. However, a plurality of additional chassis may be installed.

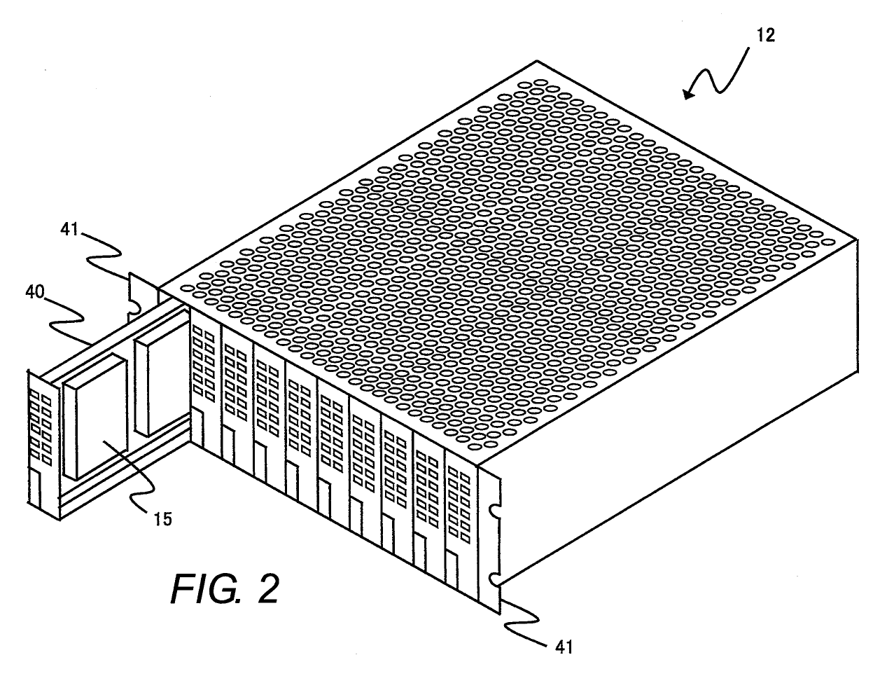

FIG. 2 illustrates, in perspective, the additional chassis 12 according to the first embodiment of this invention.

As shown in FIG. 2, the additional chassis 12 can be mounted on a chassis (e.g., 19-inch rack) by using a panel 41.

An HDD blade 40 is a base member (HDD blade) where a plurality of (e.g., 12) HDD's 15 are mounted in a depth direction. A plurality of (e.g., 10) HDD blades 40 are mounted on the additional chassis 12. The number of HDD's mounted in the HDD blade 40 is preferably even.

As shown in FIG. 2, the additional chassis 12 includes many vent holes on its upper surface. Although not shown, the additional chassis 12 also includes many vent holes on its bottom surface.

In the 19-inch rack, by a fan chassis (not shown) installed near (e.g., directly above an HDD enclosure) the HDD enclosure (e.g., additional chassis 12), heat discharged from the HDD 15 passes through a gap between the HDD blades to be sucked up to the exterior of the HDD enclosure.

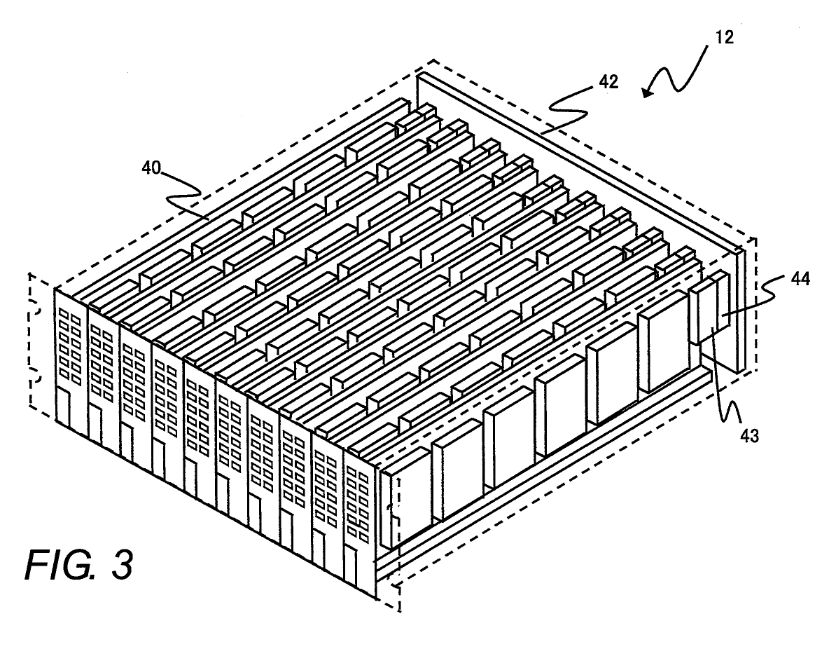

FIG. 3 illustrates an internal structure of the additional chassis 12 according to the first embodiment of this invention.

A substrate 42 is a back plane substrate on which the switch 13 and the logical circuit 14 are mounted. Connectors 43 and 44 of each HDD blade 40 and the back plane substrate 42 are coupled. The back plane substrates 42 are coupled to each other in the chassis (19-inch rack).

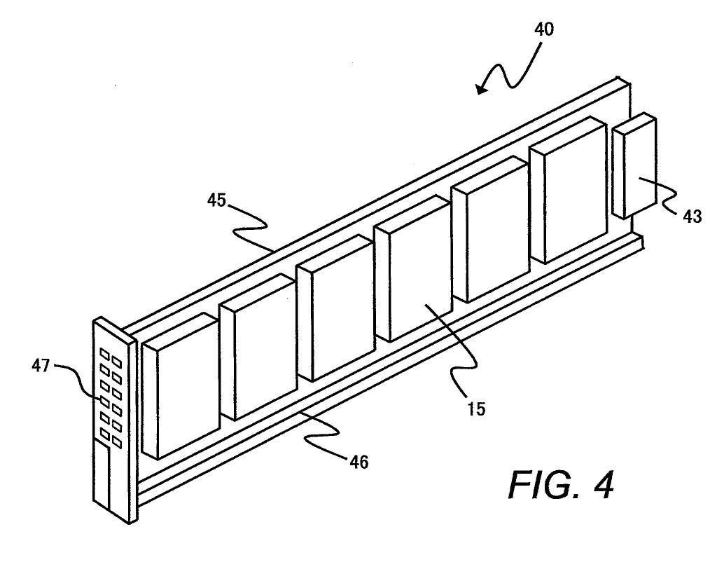

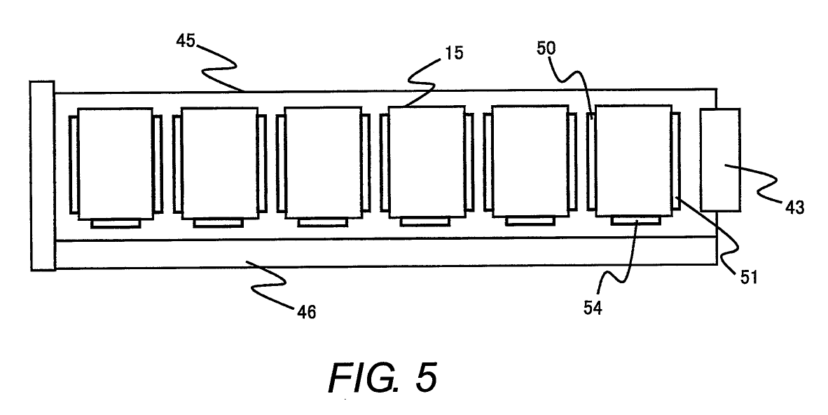

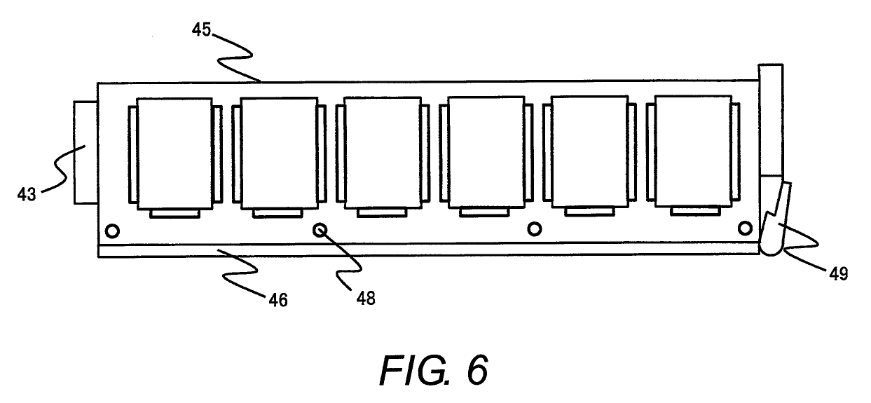

FIG. 4 illustrates, in perspective, the HDD blade 40 according to the first embodiment of this invention. FIG. 5 illustrates a right side of the HDD blade 40 according to the first embodiment of this invention. FIG. 6 illustrates a left side of the HDD blade 40 according to the first embodiment of this invention.

As shown in FIG. 4, a substrate 45 is a blade substrate. In the substrate 45, a communication interface signal line for coupling the switch 13 and the HDD 15, an HDD power control signal line drawn out from the logical circuit 14 to control power of the HDD, and an LED control signal line for lighting an LED are laid.

A material of the substrate 45 is preferably, for example, a glass epoxy resin. As shown in FIG. 4, 12 2.5-inch HDD's 15 in total, 6 in each side, may be installed in both sides of the substrate 45.

As shown in FIG. 5, each HDD 15 is fixed to the substrate 45 by support plates 50 and 51. A connector 54 is an HDD interface connector to couple the communication interface signal line and the HDD power supply line laid in the substrate 45 to the HDD 15.

Although not shown, the substrate 45 includes a voltage regulator for generating power supply voltages for the HDD 15 and the LED 47. A rail 46 is an inner rail to facilitate insertion/pulling-out of the HDD blade 40 into/from the additional chassis, and to prevent bending of the substrate 45. A material of the inner rail 46 is preferably, for example, aluminum.

As shown in FIG. 6, the inner rail 46 is fixed to the substrate 45 (e.g., fixed by screws 48).

The LED 47 is a 3-color LED, and displays an access status (e.g., ready status, active status, or error status) to each HDD 15 mounted on the HDD blade 40 by three colors (e.g., green, blue, and red).

The connector 43 is coupled to the back plane substrate 42 in the additional chassis 12, and fixed to the substrate 45 (e.g., by soldering). A lever 49 fixes the HDD blade 40 to the additional chassis 12. The HDD blade 40 is inserted into the additional chassis 12 to be coupled to the back plane substrate 42, and operates the lever 49 (e.g., rotates the lever 49), thereby fixing the HDD blade 40 to the additional chassis 12.

Next, a method of fixing the HDD 15 to the substrate 45 will be described.

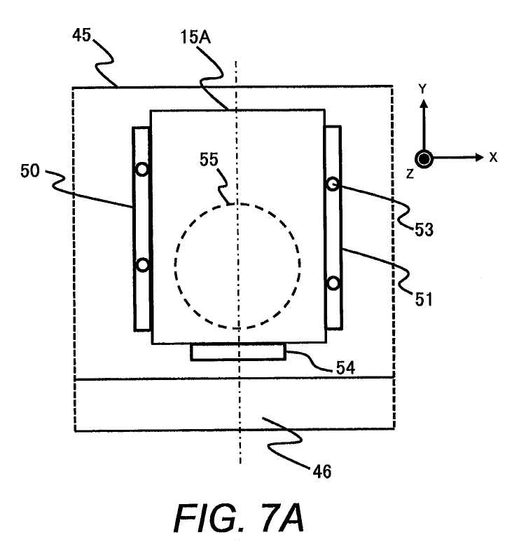

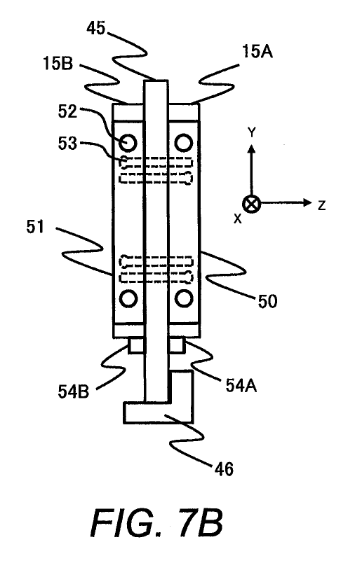

FIG. 7A is a side view of two HDD's 15A and 15B attached to the HDD blade 40 of this invention. FIG. 7B is a sectional view of the two HDD's 15A and 15B attached to the HDD blade 40 of this invention.

The HDD blade 40 is attached to the substrate 45 by the support plates 50 and 51.

Specifically, as shown in FIGS. 7A and 7B, there are four screw holes on a side face of the HDD 15, and the support plates 50 and 51 are attached by screws 52.

The two HDD's 15A and 15B to which the support plates 50 and 51 are attached are stuck to each other from both sides of the substrate 45 to be fastened together by screws 53. In this case, the HDD's 15A and 15B are coupled to HDD interface connectors 54A and 54B fixed to the substrate 45, respectively. The HDD interface connectors 54A and 54B are mounted in positions of both sides of the blade substrate 45 where Y-axis coordinates are equal to each other.

A platter 55 is a recording medium in the HDD 15. A rotational center of the platter 55 is normally present on a straight line bisecting a short side of the HDD 15. Accordingly, through the fixing method of the HDD 15, a rotational axis of the platter 55 of the HDD 15A matches that of the platter 55 of the HDD 15B.

Rotational speeds of the platters 55 (platter rotational speeds) of the HDD's 15 are equal to each other in the HDD pair (e.g., HDD 15A and HDD 15B). For example, a rotational speed is 10000 rpm. The equality in this case means that numerical values of catalog specifications are equal to each other. The numbers of platters of the HDD's 15 are preferably equal in the HDD pair (e.g., HDD 15A and HDD 15B). As a rotational direction of the platter 55 is constant, rotational directions are opposite between the platters 55 of the HDD's 15A and 15B. As rotational speeds of the platters are normally equal, rotation moments of the platters 55 of the HDD's 15A and 15B indicating vector quantity are opposite in direction but equal in length. Thus, when HDD's 15 are attached as an HDD pair to the HDD blade 40, rotation moments generated from the HDD's 15 cancel each other.

As the rotation moment has a correlation with vibrations, vibrations can be reduced by this embodiment. Specifically, when a rotation moment is generated, a force is applied on the HDD 15 to generate vibrations. Accordingly, by canceling the rotation moment, vibrations generated from the HDD 15 can be suppressed.

A disk management method in the disk array device 10 will be described below.

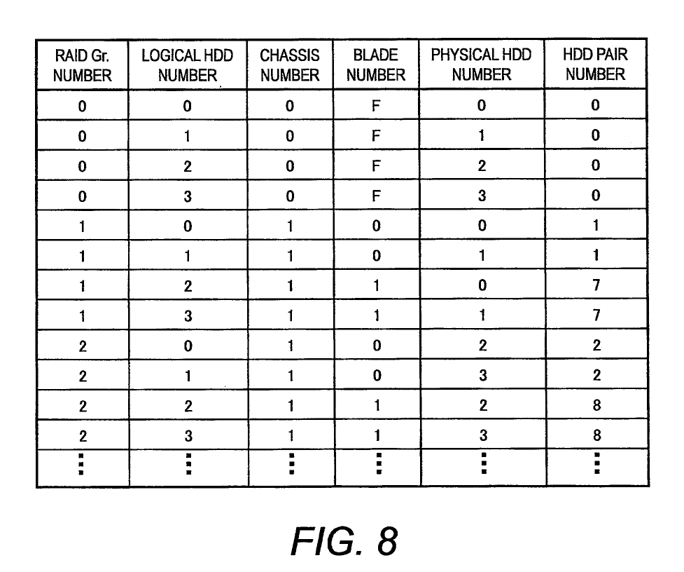

FIG. 8 illustrates a RAID configuration management table according to the first embodiment of this invention.

The RAID configuration management table of FIG. 8 is for managing correspondence between logical and physical HDD's constituting a RAID group, and stored in the local memory 22 of the controller 20.

The RAID configuration management table includes a RAID Gr. number, a logical HDD number, a chassis number, a blade number, a physical HDD number, and an HDD pair number.

The RAID Gr. number identifies a RAID group formed of HDD's 15. The RAID group is configured by dividing or combining a plurality of HDD's 15.

The logical HDD number identifies an HDD in the RAID group.

The chassis number identifies a chassis which constitutes the disk array device 10. For example, as shown in FIG. 8, a chassis number of the basic chassis 11 may be “0”, and a chassis number of the additional chassis 12 may be larger than “1”.

The blade number is allocated to the HDD blade 40 mounted in the additional chassis 12. For the blade number, for example, values of “0” to “9” are allocated. As the basic chassis 11 includes no HDD blade, a value of the blade number is F.

The physical HDD number identifies a physical HDD 15. As shown in FIG. 8, for the physical HDD number, for example, values of “0” to “11” are used. In the example of FIG. 8, “0” and “1”, “2” and “3”, “4” and “5”, “6” and “7”, “8” and “9”, and “10” and “11”, are HDD pairs where rotation moments cancel each other in the HDD blade 40.

The HDD pair number identifies an HDD pair disposed in the additional chassis 12. HDD's 15 that store identical HDD pair numbers constitute an HDD pair.

For example, the HDD pair number may indicate an HDD 15 used without constituting any HDD pair in the case of “0”, and HDD's 15 constituting an HDD pair in cases other than “0”. In this case, by retrieving an HDD pair number, for example, an HDD 15 not constituting any HDD pair as in the case of the HDD 15 disposed in the basic chassis 11 can be distinguished from HDD's 15 constituting an HDD pair as in the case of HDD's 15 disposed in the additional chassis 12.

The controller 20 can configure a RAID group by registering correspondence between a logical HDD and a physical HDD (physical HDD 15) in the RAID configuration management table. Identical HDD pair numbers indicate HDD's 15 stuck together to be arranged in the HDD blade 40.

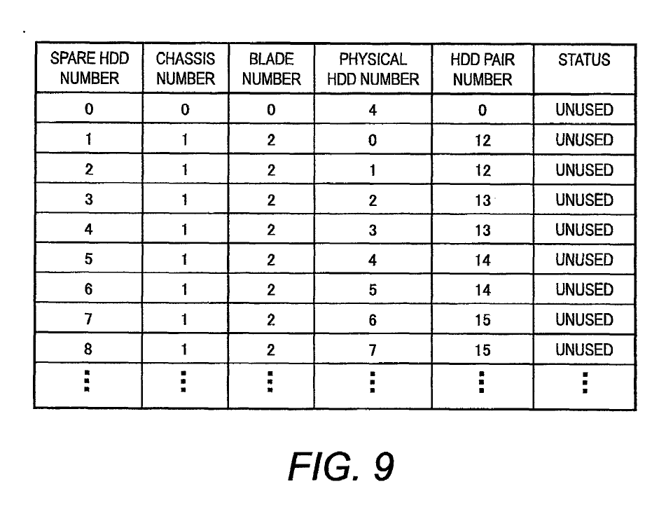

FIG. 9 illustrates a spare HDD management table according to the first embodiment of this invention.

The spare HDD management table shown in FIG. 9 is for managing correspondence between a spare HDD and a physical HDD, and stored in the local memory 22 of the controller 20.

The spare HDD management table includes a spare HDD number, a chassis number, a blade number, a physical HDD number, an HDD pair number, and a status.

The spare HDD number identifies a spare HDD. The spare HDD number is, for example, a logical number starting from “0”. The spare HDD is an HDD 15 used for recovering data when a failure occurs in an HDD 15 constituting a RAID group. Specifically, in the data recovery process, contents of data stored in the failed HDD 15 are copied in the spared HDD.

Contents of the chassis number, the blade number, the physical HDD number, and the HDD pair number are similar to those of the chassis number, the blade number, the physical HDD number, and the HDD pair number included in the RAID configuration management table, and thus description thereof will be omitted.

The status is a flag indicating whether the spare HDD is being used. When the spare HDD is used in the data recovery process, the controller 20 changes the status flag from “UNUSED” to “BEING USED”. When data stored in the HDD 15 of the RAID group is deleted to cancel the RAID group, or when the failed HDD 15 is replaced to configure a new RAID group, the status flag is changed from “BEING USED” to “UNUSED”.

The disk array device 10 has a MAID function of turning OFF power of a RAID group to which no access is made from the host computer 80. In other words, if power of a RAID group including a logical unit (LU) to which the host computer 80 has made a data I/O request is OFF, the power supply of the RAID group is changed to ON. On the other hand, if the host computer 80 has made no data I/O request to the LU constituting the RAID group for a predetermined time, the power supply of the RAID group is changed to OFF.

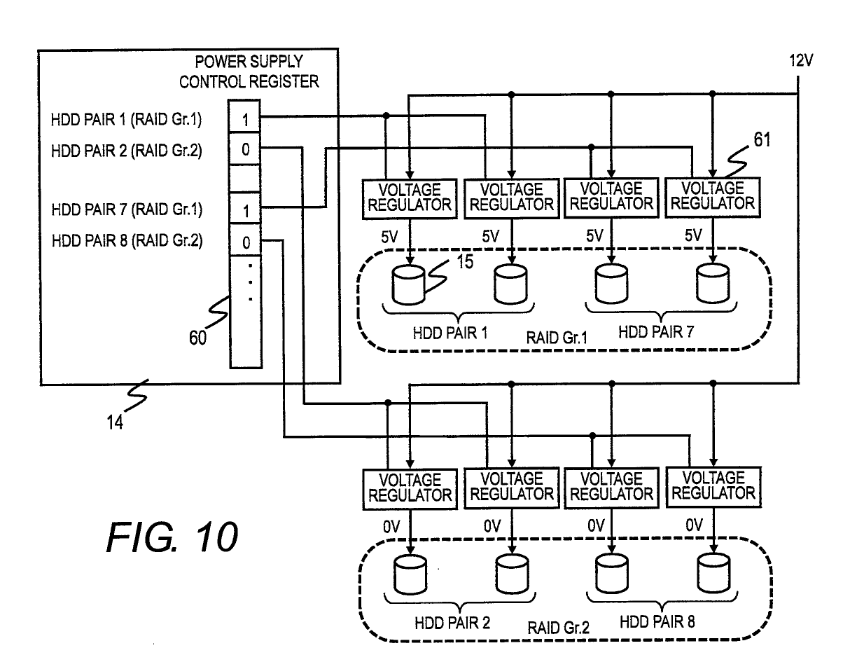

Referring to FIG. 10, a method of controlling power supply of the HDD 15 constituting the RAID group will be described.

FIG. 10 illustrates power supply control of the RAID group according to the first embodiment of this invention.

As shown in FIG. 10, the RAID group includes four HDD's 15. For example, a RAID group #1 includes HDD pairs #1 and #7, and a RAID group #2 includes HDD pairs #2 and #8.

A value is set in a power supply control register 60 included in the logical circuit 14 to control power supply of the RAID group.

Each bit set in the power supply control register 60 corresponds to the pair of HDD's stuck together to be arranged in the HDD blade 40. The power supply control register 60 may be set based on commands entered from the CPU's 21 and 31. For example, the register may be set inbound.

An HDD pair constituting the RAID group can be specified by referring to the RAID configuration management table. Accordingly, by setting a bit of the power supply control register 60 corresponding to the HDD pair to “1”, power supply of the HDD 15 constituting the RAID group can be simultaneously changed to ON. By setting a bit of the power supply control register 60 corresponding to the HDD pair to “0”, the power supply of the HDD 15 of the RAID group can be simultaneously changed to OFF. To control power supply by a RAID group unit, equal values are set in bits corresponding to an HDD pair of the same RAID group.

When “1” is set in the power supply control register 60, a voltage regulator 61 coupled to the HDD pair is turned ON. The voltage regulator 61 converts a voltage of 12 V supplied from the power supply chassis into 5 V which is an HDD driving voltage.

The voltage regulator 61 is preferably arranged near the HDD 15 in the HDD blade 40. The voltage regulator 61 may be arranged in the back plane substrate 42.

In an example of FIG. 10, each HDD 15 includes one voltage regulator 61. However, when the voltage regulator 61 has an extra output current capacity, each HDD pair may include one voltage regulator 61. In place of the voltage regulator 61, a gate circuit to which a driving voltage of the HDD 15 is entered may be used.

In the example of FIG. 10, by setting values in the power supply control register 60, the power supply of the HDD's 15 (HDD's 15 of the HDD pairs #1 and #7) of the RAID group 1 is turned ON, while the power supply of the HDD's 15 (HDD's 15 of the HDD pairs #2 and #8) of the RAID group 2 is turned OFF.

In the example of FIG. 10, by setting a value in the power supply control register 60, the power of the RAID group is controlled. However, the power of the RAID group may be controlled based on a command entered from the controller 20.

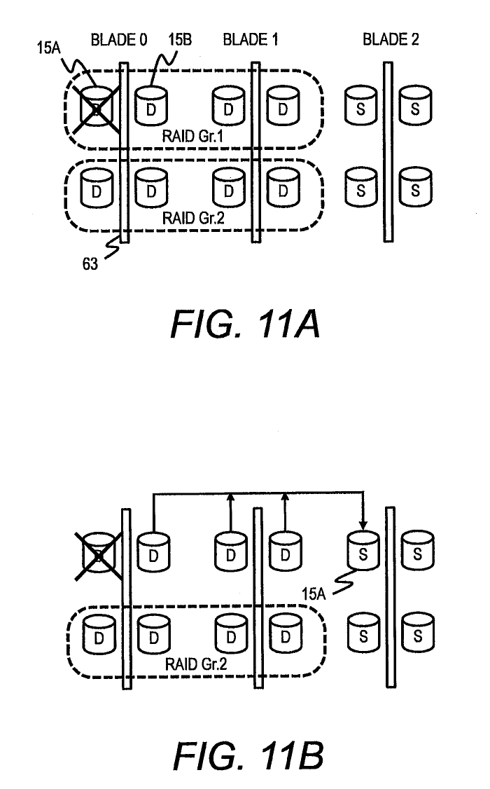

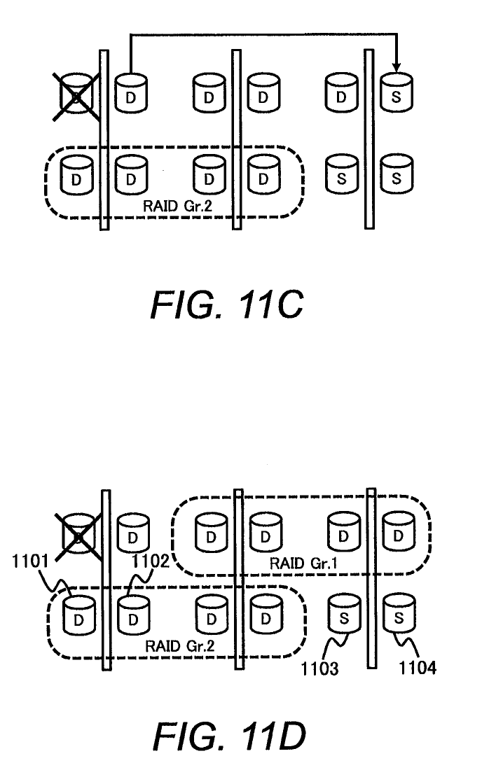

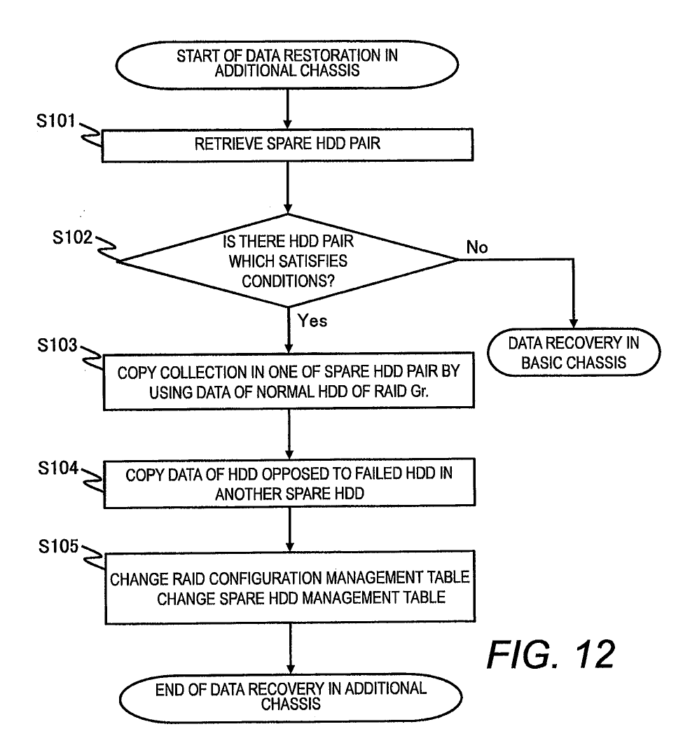

When a failure occurs in one of the HDD's 15 of the additional chassis 12 during use of the disk array device 10, data is recovered in the HDD pair. Referring to FIGS. 11 and 12, the data recovery process when the HDD 15 of the RAID group fails will be described.

FIG. 11A to FIG. 11D illustrate a data recovery process when a failure occurs in the HDD 15 according to the first embodiment of this invention. FIG. 12 is a flowchart illustrating a data recovery process when a failure occurs in the HDD 15 according to the first embodiment of this invention.

The data recovery process shown in FIG. 12 is carried out by executing a program stored in the memory 22 via the CPU 21 of the controller 20. The data recovery process may be carried out by executing a program stored in the memory 32 via the CPU 31 of the controller 30.

Referring to FIG. 11A, a process when a failure occurs in the HDD 15A of the RAID group 1 will be described. The RAID group 1 employs a RAID level 5 (RAID 5). A substrate 63 is similar to the substrate 45. HDD's 15A and 15B are arranged so that rotation moments generated by rotation of platters thereof can cancel each other.

First, the controller 20 refers to the spare HDD management table to retrieve an HDD pair of spare HDD's (spare HDD pair) whose status flag in the spare HDD management table is “UNUSED” (S101).

The controller 20 judges whether a spare HDD pair retrieved in Step S101 is present (S102). The controller 20 preferentially selects a spare HDD pair not present in the same HDD blade 40 of the failed HDD 15.

If no spare HDD pair is present, data cannot be recovered in the additional chassis 12. Accordingly, data is recovered in the basic chassis 11. On the other hand, if a spare HDD pair is present, the process proceeds to Step S103.

As shown in FIG. 11B, the controller 20 executes collection copying in one of the HDD's 15 of the spare HDD pair retrieved in Step S101 by using, in the RAID group including the failed HDD 15A, a normally operating HDD 15 (normal HDD 15) (S103).

As shown in FIG. 11C, the controller 20 copies data of the normal HDD 15B arranged by sandwiching a blade substrate (substrate 63) with the failed HDD 15A in the other HDD 15 of the spare HDD pair retrieved in Step S101 (S104).

As shown in FIG. 11D, the controller 20 updates values of the blade number, the physical HDD number, and the HDD pair number of the RAID configuration management table, and the status flag of the spare HDD management table (S105). Specifically, the controller 20 changes the blade number from blade 0 to blade 2, the physical HDD number to a physical HDD number of a copy destination spare HDD, the HDD pair number to an HDD pair number of the copy destination spare HDD, and the status flag from “UNUSED” to “BEING USED”.

To replace the failed HDD 15A, data stored in the HDD 15 present in the same HDD blade 40 of the failed HDD 15A has to be copied in each spare HDD to be replaced by an HDD blade unit. In this case, as in the case of the process shown in FIG. 12, a spare HDD pair is retrieved, and the data is copied in the retrieved spare HDD pair. After completion of the data copying, the HDD blade 40 is replaced. In the example of FIG. 11D, a spare HDD pair of HDD's 1101 and 1102 of the RAID group 2 which are present in the same HDD blade 40 as the failed HDD 15A is retrieved. Then, data of the HDD's 1101 and 1102 are copied in retrieved HDD's 1103 and 1104. After completion of data copying, the HDD blade 40 of the blade 0 is replaced.

According to the first embodiment of this invention, the power supply is controlled for each RAID group. However, for example, power supply is controlled for each group (disk group) which includes a plurality of HDD pairs as units.

According to the first embodiment of this invention, the HDD's constituting the RAID group are arranged as a pair in the HDD blade so that rotation moments can cancel each other, and the power supply is controlled so that start timings of the HDD's constituting the RAID group can be identical to each other. Thus, rotation moments between the HDD's of the pair can be cancelled during spinning-up, enabling suppressing of vibrations.

By suppressing vibrations of the HDD, a collision of the head with the platter can be prevented. Moreover, response to access to the HDD can be improved.

An influence of vibrations of the HDD is known to have a correlation with the number of error correction times. Thus, suppression of vibrations can be checked by a self-monitoring analysis and reporting technology (SMART) function which is a self-diagnosing function of the HDD.

In a mode where HDD's are mounted at a high density in a disk array device of limited physical space, vibrations of the HDD can be suppressed.

### Second Embodiment

A second embodiment of this invention will be described below.

In the case of the first embodiment, depending on tolerance of the HDD 15 attached to the HDD blade 40 and eccentricity of the platter in the HDD 15, cancellation of rotation moments between the HDD's of the pair may be insufficient.

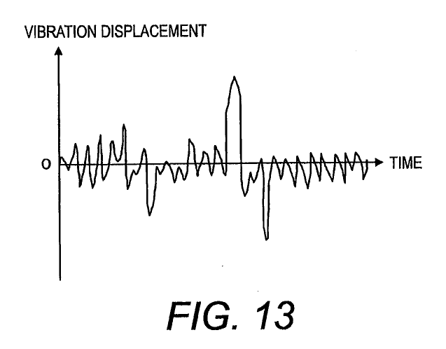

Thus, according to the second embodiment, regarding residual vibrations generated by two HDD's 15, when vibrations shifted from each other in phase by a predetermined time and opposite to each other in displacement in a direction (hereinafter, direction of the Z axis) vertical to the HDD blade 40 are superimposed as shown in FIG. 13, the residual vibrations are suppressed by using an acceleration sensor. The direction vertical to the HDD blade 40 is, for example, a direction vertical to a surface of the HDD blade 40 where vent holes are present.

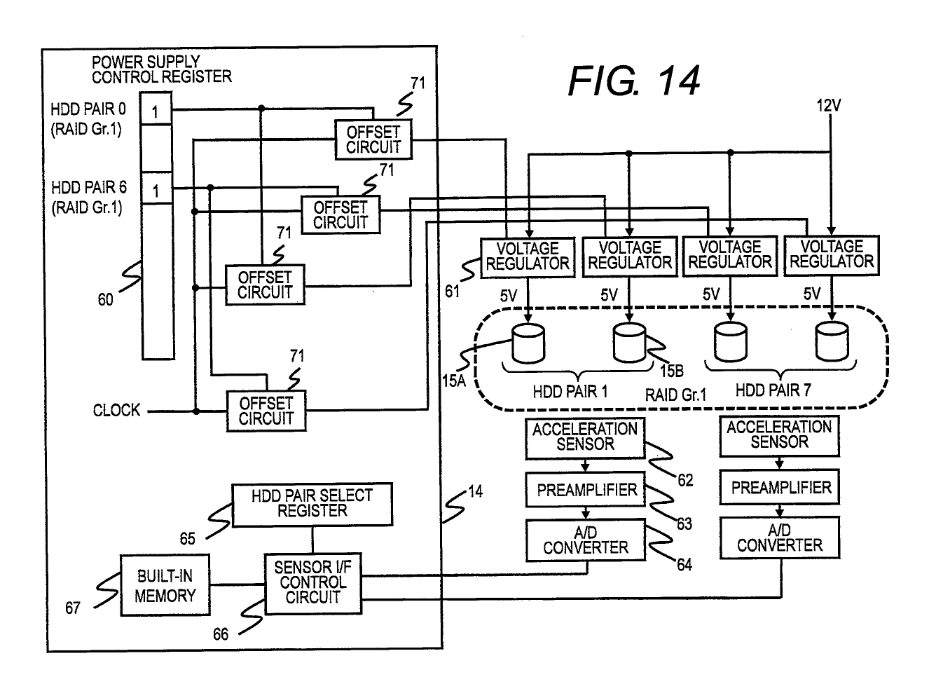

FIG. 14 illustrates power supply control of an HDD pair according to the second embodiment of this invention.

The additional chassis 12 includes an acceleration sensor 62, a preamplifier 63, and an A/D converter 64 for each HDD pair.

The acceleration sensor 62 is arranged near an HDD pair disposed in a substrate 45 to measure acceleration of an HDD 15 of a z-axis direction.

The preamplifier 63 amplifies an analog signal output from the acceleration sensor 62.

The A/D converter 64 converts the analog signal amplified by the preamplifier 63 into a digital signal.

The preamplifier 63 and the A/D converter 64 are preferably arranged near the acceleration sensor 62 disposed in the substrate 45. They may be arranged in the back plane substrate 42, or incorporated in the logic circuit 14.

The logic circuit 14 includes a power supply control register 60, an HDD pair select register 65, a sensor I/F control circuit 66, a built-in memory 67, and an offset circuit 71.

As in the case of the power supply control register shown in FIG. 10, the power supply control register 60 controls power supply of an HDD 15 constituting a RAID group by setting a value in the register.

The HDD pair select register 65 selects an HDD pair upon setting of a value in the register. For example, the HDD pair select register 65 includes a bit corresponding to each HDD pair, and an HDD pair corresponding to a bit set to “1” is selected.

The sensor I/F control circuit 66 fetches digital signals converted by the A/D converter 64 at a predetermined cycle. The fetched digital signals are written in the built-in memory 67. Specifically, the sensor I/F control circuit 66 obtains, according to contents of the HDD pair select register 65 set by the controller 20, acceleration data from the A/D converter 64 corresponding to the HDD pair at a sampling frequency of 10 kHz, and stores the obtained acceleration data in the built-in memory 67. The sensor I/F control circuit 66 may include, for example, a microcontroller or a state machine.

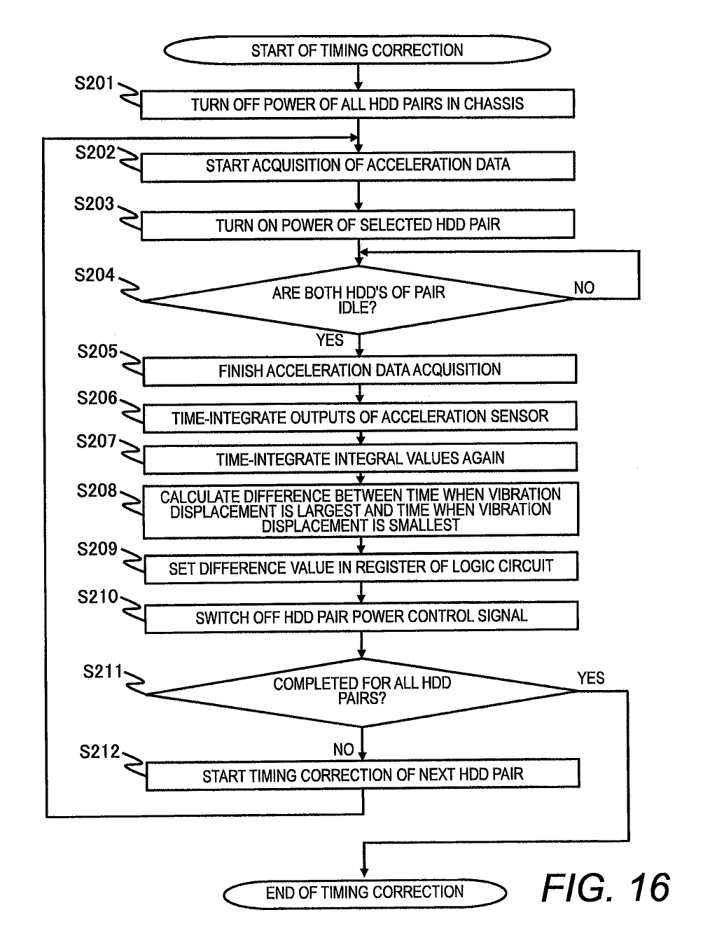

The offset circuit 71 controls timing of switching power supply according to correction of power supply timing described below referring to FIG. 16.

The controller 20 corrects, after the HDD's 15 of the additional chassis 12 constitute a RAID group, timing of controlling power supply of one of the HDD's of a pair (e.g., turning power ON).

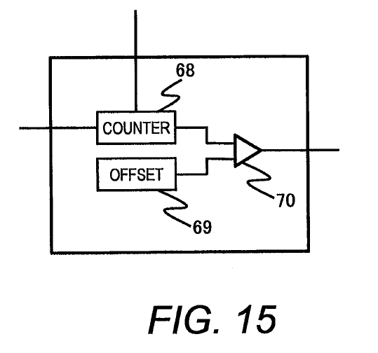

FIG. 15 is a block diagram showing the offset circuit 71 according to the second embodiment of this invention.

The offset circuit 71B includes a counter 68, an offset 69, and a comparator 70. The counter 68 counts the number of clocks based on a clock cycle. In the offset 69, a correction value of power supply timing is set.

The comparator 70 compares a value of the counter 68 with a value of the offset 69. When a value of the counter 68 reaches a value of the offset 69, the comparator 70 outputs a signal for controlling power to the voltage regulator 61.

FIG. 16 is a flowchart showing a process for correcting power supply timing according to the second embodiment of this invention.

The process shown in FIG. 16 is carried out by executing a program stored in a memory 22 by the CPU 21 of the controller 20.

First, the controller 20 turns OFF power supply of all the HDD pairs of the additional chassis 12 (S201).

The controller 20 selects an HDD pair constituting a RAID group, and sets a value in the HDD pair select register 65 of the logic circuit 14. The controller 20 obtains acceleration data corresponding to the selected HDD pair (selected HDD pair) (S202).

The controller 20 sets a value in the power supply control register 60 corresponding to the selected HDD pair to turn ON power supply of the selected HDD pair (S203).

The controller 20 judges whether two HDD's 15 constituting the selected HDD pair are idle (S204).

If the two HDD's 15 are idle, the process proceeds to Step S205. On the other hand, if neither of the two HDD's 15 are idle, the process stands by until the two HDD's 15 become idle.

The controller 20 clears the HDD pair select register 65 to finish the acquisition of acceleration data (S205).

Then, the controller 20 obtains acceleration data from the built-in memory 67 to integrate the obtained acceleration data by time (S206). Data obtained by integrating the obtained acceleration data indicates a speed of vibrations.

The controller 20 further integrates the data integrated in Step S206 by time (S207). The data integrated in Step S207 indicates displacement of vibrations (amount of vibrations). A platter rotational speed of the HDD is 10.000 rpm, and a cycle of one rotation of the platter is 6 milliseconds. Accordingly, for example, when measuring time is 10 milliseconds, the platter makes one rotation or more, and thus vibrations caused by a platter rotational frequency can be obtained. FIG. 13 illustrates an example of a vibration waveform.

Then, based on the displacement data obtained in Step S207, the controller 20 observes relative time when a vibration takes a maximum value (e.g., from time when obtaining acceleration data is started to time when a vibration takes a maximum value) and relative time when a vibration takes a minimum value (e.g., from time when obtaining acceleration data is started to time when a vibration takes a minimum value), and obtains time of a difference (timing correction value) between the retrieved relative time when a vibration takes the maximum value and the retrieved relative time when a vibration takes the minimum value (S208).

The controller 20 divides the timing correction value obtained in Step S208 by a clock cycle, and sets a divided value in the offset register 69 of the offset circuit 71 (S209). An initial value of the offset register 69 is 0. In this case, the timing is not corrected, and thus power supplies of the HDD pairs are simultaneously turned ON.

The controller 20 turns OFF power supply of a selected HDD pair (S210).

The controller 20 judges whether timings of all the HDD pairs have been corrected (S211). Specifically, the controller 20 obtains acceleration data of all the HDD pairs, and judges whether a timing correction value has been set in the offset register 69.

If the timings of all the HDD pairs have been corrected, the process is finished. On the other hand, if the timing of at least one HDD pair has not been corrected, the process proceeds to Step S212. Upon end of the process, according to a request from a client (e.g., host computer 80), a status which enables control of power supplies of the HDD pair is set (ready status).

The controller 20 changes values of the HDD pair select register 65 in order (e.g., sets a value in next bit) (S212). Then, the process returns to Step S202 to similarly set, for a next HDD pair (e.g., another HDD pair of the same RAID group), a timing correction value for turning power supply ON in the offset register 69.

In the example of FIG. 14, the process of FIG. 16 is executed, and the power supply control register 60 is set to first turn ON power supply of one HDD 15A of the HDD pair constituting the RAID group 1. At this time, power supply of the other HDD 15B of the HDD pair is kept OFF. Subsequently, a value of the counter 68 is incremented in synchronization with a clock of the logic circuit 14. When the value of the counter 68 reaches the value of the offset register 69, the power supply of the other HDD 15B of the HDD pair is turned ON in response to an output from the comparator 70.

As described above, as shown in FIG. 13, the maximum and minimum components of displacement of vibrations of opposite displacing directions which are shifted in phase by predetermined time and superimposed together are canceled each other. Thus, vibrations applied on the other HDD can be further reduced.

### Third Embodiment

According to the first embodiment of this invention, the number of HDD's 15 constituting the RAID group is even. According to a third embodiment, however, by using an HDD 15 of another chassis (e.g., basic chassis 11) for which no influence of vibrations has to be taken into consideration, this embodiment can be applied to a case where the number of HDD's 15 constituting a RAID group is odd.

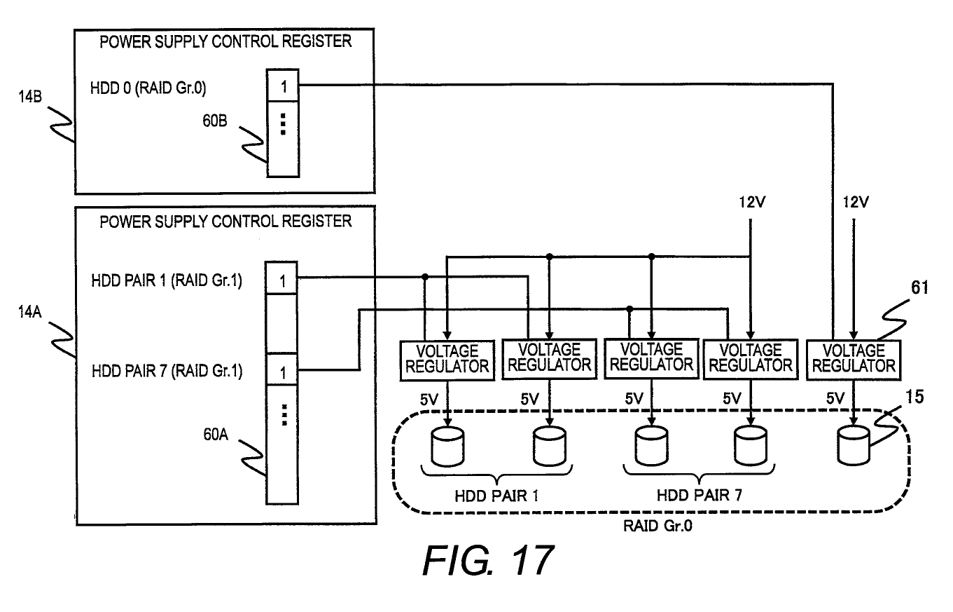

FIG. 17 illustrates power supply control of a RAID group according to the third embodiment of this invention.

As shown in FIG. 17, for example, a RAID group can consist of the even number of HDD's 15 including HDD pairs of an additional chassis 12 and the odd number of HDD's 15 of a basic chassis 11.

In an example shown in FIG. 17, a RAID group consists of four HDD's 15 of the additional chassis 12 and one HDD 15 of the basic chassis 11.

Each bit of a power supply control register 60B of the basic chassis 11 is allocated for each HDD. A method of controlling power supply of the HDD pair of the additional chassis 12 is similar to the method of the first embodiment of this invention.

Thus, according to the third embodiment of this invention, even when the number of HDD's 15 constituting a RAID group is odd, HDD vibrations can be suppressed.

While the present invention has been described in detail and pictorially in the accompanying drawings, the present invention is not limited to such detail but covers various obvious modifications and equivalent arrangements, which fall within the purview of the appended claims.

What is claimed is:

1. A disk array apparatus, comprising:
a plurality of disk drives; and
a controller for controlling the plurality of disk drives,
the disk array apparatus controlling power of the plurality of disk drives for each disk group including of the plurality of disk drives, wherein:
the two disk drives included in the same disk group are arranged in sets on one base member; and
the controller controls to set start timings of the two disk drives constituting the set identical to each other.

2. The disk array apparatus according to claim 1, wherein the controller supplies power to the two disk drives constituting the set at identical timings.

3. The disk array apparatus according to claim 1, further comprising a blade which includes the plurality of disk drives arranged in a depth direction of a chassis for mounting the plurality of disk drives,
wherein the two disk drives are arranged one on each side of the blade.

4. The disk array apparatus according to claim 1, wherein the two disk drives are arranged so that rotational axes thereof are on a certain line.

5. The disk array apparatus according to claim 1, wherein rotational speeds of the two disk drives are equal to each other.

6. The disk array apparatus according to claim 1, wherein the two disk drives comprise equal numbers of platters.

7. The disk array apparatus according to claim 1, further comprising at least a first spare disk drive and a second spare disk drive constituting a set that are used when a failure occurs, wherein:
the first and second spare disk drives are arranged in sets of two on one base member;
the plurality of disk drives include a first active disk drive and a second active disk drive constituting a set; and
the controller is configured to:
reconstruct data stored in the first active disk drive by using data stored in second active disk drive and other disk drives included in the disk group to store the reconstructed data in the first spare disk drive, when a failure occurs in the first active disk drive;
store the data stored in the second disk drive in the second spare disk drives; and
add the first and second spare disk drives to the disk group.

8. The disk array apparatus according to claim 1, wherein the disk group is a RAID group.

9. The disk array apparatus according to claim 1, wherein the controller controls power of the plurality of disk drives based on a command.

10. The disk array apparatus according to claim 1, wherein the disk group is configured based on arrangement information of the plurality of disk drives.

11. The disk array apparatus according to claim 1, wherein the controller supplies power to the two disk drives constituting the set with a predetermined time interval therebetween.

12. The disk array apparatus according to claim 11, wherein the predetermined time interval is set for every two disk drives constituting the set.

13. The disk array apparatus according to claim 11, wherein the controller is configured to:
observe vibrations generated when the two disk drives start; and
calculate the predetermined time interval so that the observed vibrations cancel each other.

14. A disk array apparatus, comprising:
a plurality of disk drives; and
a controller for controlling the plurality of disk drives,
the disk array apparatus controlling power of the plurality of disk drives for each disk group including of the plurality of disk drives, wherein:
the disk group includes a first disk group having an even number of disk drives and a second disk group having an odd number of disk drives;
the two disk drives included in the first disk group are arranged in sets on one base member;
the disk drives included in the second disk group are mounted in a chassis different from a chassis of the disk drives included in the first disk group; and
the controller controls to set start timings of the two disk drives constituting the set identical to each other.
